(19) United States
(12) Patent Application Publication
(10) Pub. No.: US 2024/0177227 A1
(43) Pub. Date: May 30, 2024

(54) SYSTEM AND METHOD OF FACILITATING LENDING AND/OR RENTING OF ITEMS

(71) Applicants: Kailan PAUL, Springfield (AU); Joel ROMERO, Wyee Point (AU)

(72) Inventors: Kailan PAUL, Springfield (AU); Joel ROMERO, Wyee Point (AU)

(21) Appl. No.: 18/294,841

(22) PCT Filed: Aug. 2, 2022
(86) PCT No.: PCT/AU2022/050823

§ 371 Date: Feb. 2, 2024

(30) Foreign Application Priority Data
Aug. 3, 2021 (AU) 2021902393

(51) Int. Cl. G06Q 30/0645; G06Q 10/087; G06Q 30/0201; G06Q 30/0601

(52) U.S. Cl. CPC G06Q 30/0645; G06Q 10/087; G06Q 30/0206; G06Q 30/0627; G06Q 30/0639

(57) ABSTRACT

The present invention relates to a computer-implemented system and method for matching an individual or organisation offering items for lending and/or renting with other individuals or organisations seeking to locate items which they prefer to borrow and/or rent. In particular, the method includes receiving a request from a data communications device associated with a first user of a plurality of users to list an item as available for borrowing and/or renting, wherein the first user request includes information relating to the item including a description of the item and a location of the item, generating a listing in which the item description is displayed, receiving a request from a data communications device associated with a second user of the plurality of users to search for a particular item or a particular category of items in respect of which the second user has an interest, wherein the second user request includes information relating to the second user including a location of the second user, and based on the item requested to be listed by the first user being determined as a match for the particular item or the particular category of items included in the second user request, and further based on the location of the item residing within a predetermined geographical region of the second user, including the generated listing in search results presented to the second user.

### FIELD OF THE INVENTION

The present invention relates to a computer-implemented system and method for matching an individual or organisation offering items for lending and/or renting with other individuals or organisations seeking to locate items which they prefer to borrow and/or rent.

### BACKGROUND OF THE INVENTION

Reference to “borrow” or “lend” herein is intended to mean the handing over of an item or items from one individual or entity to another for a limited period of time at no expense to the individual or entity borrowing the item(s). The reference to “rent” herein is intended to mean the handing over of an item or items from one individual or entity to another for a limited period of time in exchange for monetary or other compensation.

There are various known computer-implemented platforms that offer users the ability to search for items which other users have posted on the same platform on the basis that such items are available for purchase. However, there is a growing trend regarding consumers seeking to borrow or rent rather than purchase items, particularly items that are expensive when purchased outright or items which individuals are likely to use only once or infrequently.

An example of such an item is clothing for a special occasion, e.g. a tuxedo or gown which may be required once, or only on a few occasions, when an individual needs to attend a special event. The purchase price of a tuxedo or gown could extend into the hundreds, if not thousands of dollars, and hence it is often preferable to borrow or rent such a garment to wear once before returning same to the owner after the event.

Party goods represent another example of items that are more likely to be borrowed or rented rather than purchased. For example, large cooking devices such as spit roasters and pizza ovens can be expensive to purchase, tend to be large and bulky, and may also require trained personnel to use, hence such items are more likely to be borrowed or rented for use at an event rather than purchased.

Yet another example of items that are likely to be borrowed or rented rather than purchased are those offered as part of a user experience. An example of an item associated with a user experience includes a sports car that an individual can drive as part of a driving experience, or a hot air balloon that may be experienced as part of a hot air balloon experience. Clearly, such items are too expensive for an average individual to purchase outright, hence experiences are created to enable individuals unable to purchase certain items to experience the item for a limited time in exchange for monetary or other compensation (rent).

The above-described items represent the more common types of items that are available for borrowing and/or renting. However, there exist various other items that users may have an interest in borrowing and/or renting that are not typically available for borrowing and/or renting and hence can be very difficult to locate. For example, a user may have a need for a particular piece of gardening equipment they prefer not to purchase (since they propose to use the equipment only once), or it may be that the piece of equipment is too expensive. There is currently no known quick and efficient means known to the Applicant for users to locate particular pieces of equipment within their geographical vicinity for the purpose of borrowing or renting same.

Accordingly, a problem faced by users is the limited ability to locate items of interest that are available for borrowing and/or renting, particularly rare items which are not typically available for such purposes. Even if an advertisement or directory for borrowing or renting an item is located by a user, there is no guarantee that the item will be within a reasonable vicinity of the user and it is often not until the user has made various enquiries regarding the state or quality of the item that its location may be ascertained. Accordingly, a user could spend many hours searching online for particular items of interest that may be available for lending and/or renting, including making enquiries, only to be advised that the item is not what they expected or is located a significant distance from their location. For example, details such as the state or quality of the item, the location of the item, what components and accessories are included, etc, may not be disclosed or displayed in advertisements or directories being searched.

Similar problems arise for users seeking to lend and/or rent items they own, since the means for listing such items for public viewing are limited and it can be equally difficult for users to locate others who may have an interest in borrowing and/or renting particular items and who are located within a practical distance to collect and return the item(s).

The above-described problems also give rise to the unnecessary usage of computer and memory resources since web browsers, mobile phones and similar communication devices are used, on the one hand to locate items of interest that are available for borrowing and/or renting, and on the other hand to find users who may be interested in borrowing and/or renting items. For example, using existing functionality of a mobile device to search for a website and/or engage in related communications for the above purposes has the effect of consuming substantial data communications bandwidth and hence results in significant computer and network resource usage. Inefficient use of the available bandwidth of data communications networks is clearly undesirable since this has the effect of increasing latency of communications, and slow and/or unreliable communications are frustrating (and expensive) for users. This problem is exacerbated during times of high network traffic consuming available bandwidth.

The computer-implemented system and method of the present invention seeks to ameliorate the above identified problems or at least provide an alternative solution to same.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method including receiving, by one or more processors, a request from a data communications device associated with a first user of a plurality of users to list an item as available for borrowing and/or renting, the first user request including information relating to the item including a description of the item and a location of the item, generating, by one or more processors, a listing in which the item description is displayed, receiving, by one or more processors, a request from a data communications device associated with a second user of the plurality of users to search for a particular item or a particular category of items in respect of which the second user has an interest, the second user request including information relating to the second user including a location of the second user, based on the item requested to be listed by the first user being determined as a match for the particular item or the particular category of items included in the second user request, and further based on the location of the item residing within a predetermined geographical region of the second user, including the generated listing in search results presented to the second user.

In an embodiment, the method further includes providing a search facility enabling the second user to conduct a search for a particular item or a particular category of items of interest, wherein in response to a search conducted by the second user using the search facility, the second user may be presented with only those listings that match the particular item or particular category of items specified in the first user request, and only those listings within the predetermined geographical region of the second user.

In an embodiment, each of the first and second users utilise a software application operable on the respective data communications devices to transmit the first and second requests respectively.

In an embodiment, the software application enables the second user to define the predetermined geographical region of the second user.

In an embodiment, the software application enables the second user to define more than one geographical region.

In an embodiment, determining a match between the item requested to be listed by the first user with the particular item or the particular category of item included in the second user request includes determining that similarities between the first and second user requests satisfy a similarity threshold.

In an embodiment, the method further includes identifying, utilising one or more optical character recognition techniques, letters, words, numbers and/or symbol included in each of the first and second user requests, wherein the similarity threshold is based upon an extent to which particular letters, words, numbers and/or symbols identified in the first user request match those identified in the second user request.

In an embodiment, the method further includes utilising one or more machine learning techniques to improve the optical character recognition over time based upon feedback including user feedback regarding an accuracy of optical recognition of recognising the particular letters, words, numbers and/or symbols.

In another embodiment, the method further includes storing, in a predefined location, similarity scores for various combinations of letters, words, numbers and/or symbols, determining, based upon the stored similarity scores, similarity score(s) for particular combinations of letters, words, numbers and/or symbols compared for determining whether the respective user requests satisfy the similarity threshold, and determining that the similarity threshold is satisfied in respect of the first and second user requests when the determined similarity score(s) exceed(s) a predetermined minimum. In this regard, determination regarding the similarity between particular letters, words, numbers and/or symbols may depend upon the similarity exceeding a threshold score as compared with the scores saved in the cloud based facility.

In an embodiment, the method further includes determining similarity scores for remaining combinations of letters, words, numbers and/or symbols in the respective user requests, and where more than one similarity score is determined, determining a combined similarity score and whether the combined similarity score exceeds the predetermined minimum.

In an embodiment, when a similarity score for a particular pair of letters, words, numbers and/or symbols is not stored in a predefined location, the method further includes determining the similarity score(s) based upon any remaining letters, words, numbers and/or symbols in the respective user requests, and prompting the second user to add additional search terms to the second user request to enable the determination of similarity score(s) pertaining to letters, words, numbers and/or symbols added by the second user. Any newly determined similarity score(s) for particular combinations of letters, words, numbers and/or symbols may also be stored in the predefined location for future reference. Accordingly, the similarity scores may be updated according to successful matchings between first and second user requests and hence, the predefined location may learn from successful matchings between requests and, for example, associate higher similarity scores according to the particular combination of letters, words, numbers and/or symbols used in respective first and second user requests.

In an embodiment, the method further includes maintaining a status of the item, including whether the item is currently borrowed or rented, or alternatively, whether the item is currently available for borrowing or renting.

In an embodiment, if the status of the item is currently borrowed or rented, the item listing is included in the search results presented to the second user based on the respective user requests satisfying the similarity threshold, to enable the second user to borrow or rent the item after the item is returned. In this embodiment, the method may further include updating the item listing included in the search results such that the updated listing specifies an expected return date of the item.

In an alternative embodiment, the search results include only those listings relating to items that are currently available for borrowing or renting.

In an embodiment, when a first user lists an item for renting, the first user is prompted to include one or more periods of time for which the item may be rented, and a rental fee.

In an embodiment, when a first user lists an item for lending, the first user is prompted to include one or more periods of time for which the item may be borrowed, and the item listing is automatically updated to confirm that no fee is payable to the first user for borrowing the item.

In an embodiment, the method further includes, based upon the second user selecting an item listing from the search results, wherein the item is available for rent, prompting the second user to confirm their intention to rent the item and to confirm the rental period if there are multiple rental period options.

In an embodiment, based upon receiving confirmation from the second user regarding an intention to rent the item, the second user may be prompted to pay the rental fee, or a portion thereof, to the first user. In this regard, at least the first user may be prompted to provide their bank account details when first registering to use the software application or when subsequently listing an item, and the software application may provide a payment gateway to the second user to enable the second user to make payments into a bank account associated with the first user.

In an embodiment, the software application enables each user to create a user profile viewable by other registered users. When generating a user profile, each user may be prompted to provide a level of information sufficient to enable each user to be identified. For example, each user may be prompted to upload a facial image which may undergo facial recognition or other analysis that may be used to verify the identity of the user seeking to create a profile.

In an embodiment, the software application enables ratings of users whereby the rating of users may also be viewable in the user profiles. For example, the second user may rate the first user regarding the item they borrowed or rented and the extent to which the item matched the description provided in the item listing, and the first user may rate the second user based upon factors such as when the item was returned (i.e. the timeliness of the return) and/or the state of the item upon its return.

In an embodiment, data relating to the activity of users may be recorded for the purpose of generating statistical data in relation to those items that users seek to borrow and/or rent most regularly, items that are sought but which requests are typically not fulfilled by first users within a particular geographical region or regions, etc. Potential opportunities may arise from collating such data, including the identification of sales or rental opportunities for retailers to fulfil the requirements of second users seeking to borrow and/or rent items of interest. For example, a retailer may choose to start offering such items for rent (in addition to purchase). In another example, a retailer may choose to target those users with advertising in relation to the item(s) of interest, including when particular items are on sale.

In an embodiment, search histories may be retained in respect of each of the second users to enable the second users to revive a previous search. In addition, any search conducted by a second user may remain active until such time that an item of interest is located. For example, if a match is not immediately identified, the search may remain active and will automatically update based upon new items listed by first users, so that the second user seeking to borrow or rent an item of interest may be notified of the newly listed item (e.g. by push notification, text message or email).

In an embodiment, the method further includes generating one or more recommendations for first users listing items for rent, including recommendations regarding a suitable rental fee for the particular item being listed as compared with market value. Likewise, one or more recommendations may be generated for second users searching for items of interest, including recommendations regarding whether a listed rental fee is substantially commensurate with fees previously proposed by other first users in respect of the same or similar items.

In another aspect, the present invention provides a system including one or more processors operable to receive a request from a data communications device associated with a first user of a plurality of users to list an item as available for borrowing and/or renting, the first user request including information relating to the item including a description of the item and a location of the item, generating a listing in which the item description is displayed, receiving a request from a data communications device associated with a second user of the plurality of users to search for a particular item or a particular category of items in respect of which the second user has an interest, the second user request including information relating to the second user including a location of the second user, and based on the item requested to be listed by the first user determined as a match for the particular item or the particular category of items included in the second user request, and further based on the location of the item residing within a predetermined geographical region of the second user, including the generated listing in search results presented to the second user.

In a third aspect, the present invention provides a computer-readable medium having a plurality of computer instructions executable by one or more processors that, when executed, causes the one or more processors to receive a request from a data communications device associated with a first user of a plurality of users to list an item as available for borrowing and/or renting, the first user request including information relating to the item including a description of the item and a location of the item, generate a listing in which the item description is displayed, receive a request from a data communications device associated with a second user of the plurality of users to search for a particular item or a particular category of items in respect of which the second user has an interest, the second user request including information relating to the second user including a location of the second user, and based on the item requested for listing by the first user determined as a match for the particular item or the particular category of items included in the second user request, and further based on the location of the item residing within a predetermined geographical region of the second user, include the generated listing in search results presented to the second user.

### BRIEF DESCRIPTION OF THE DRAWINGS

Features of the present disclosure are illustrated by way of example and not limited in the following Figure(s), in which like numerals indicate like elements, in which:

FIG. 1 provides an overview of a system according to an embodiment of the present invention showing, in particular, the interaction of various system components.

FIG. 2 illustrates an diagram associated with an exemplary server component of the system illustrated in FIG. 1.

FIG. 3 illustrates an exemplary flow diagram of a process that enables a user to download and install a software application, and subsequently access, or register, to use the software application for interaction with the system illustrated in FIG. 1.

FIG. 4 illustrates an exemplary flow diagram of a process that enables a user to use the software application to establish a user profile and list/manage an item available for borrowing and/or renting.

FIG. 5 illustrates an exemplary flow diagram of a process that enables a second user to search for an item in respect of which the second user has an interest and which the second user may seek to borrow or rent.

FIG. 6 illustrates an exemplary flow diagram of a process that enables the processing of payments between the first and second users.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. It will be readily apparent, however, that the current disclosure may be practiced without limitation to the specific details. In other instances, some methods and structures have not been described in detail to avoid obscuring the present disclosure.

The present invention relates to at least a computer-implemented system and method of facilitating lending and renting of items between users. The system and method provide a platform that hosts a computer executable software application (40) wherein the application (40) is accessible by a plurality of registered users (30), including users (30A) who utilise the platform to lend or rent out items, and users (30B) who use the platform to borrow or rent items from the users (30A). In particular, the system utilises a central server (20) in communication with data communication devices (50) associated with each user (30).

It will be appreciated that general reference to user (30) herein is intended to reference either one or both of users (30A) and (30B).

The central server (20) maintains one or more processors and/or databases for performing functions, including receiving from a computing device (50) of a first user (30A) of the plurality of registered users, a request to list an item (60) as being available for borrowing and/or renting (also referred to herein as a “first request”), wherein the request includes information relating to the item (60) including a description (65) of the item and a location (112) of the item (60), and generating an item listing (190) in which the item (60) and the item description (65) is displayed. The central server (20) subsequently receives a request from a data communication device (50) associated with a second user (30B) to search for a particular item or a particular category of items in respect of which the second user (30B) has an interest (also referred to herein as a “second request”), wherein the second request also includes information relating to the second user (30B) including a location of the second user (30B). Based upon the item requested to be listed by the first user (30A) being determined as a match for the particular item or the particular category of items included in the second user (30B) request, and further based upon the location (112) of the item (60) residing within a predetermined geographical region of the second user (30B), the generated listing (210) is included in search results (180) presented to the second user (30B).

The skilled person will appreciate that the platform provides a marketplace for users (30A) to lend/rent out items (60) to other users (30B), by allowing users (30B) to browse and search for items that are available for borrowing and/or renting in their local area.

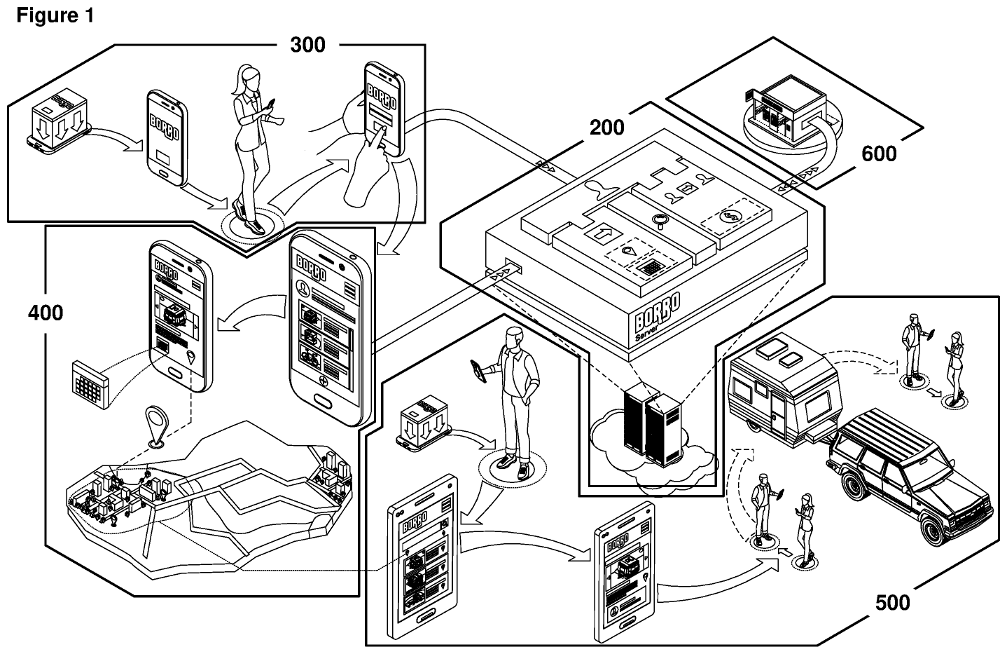

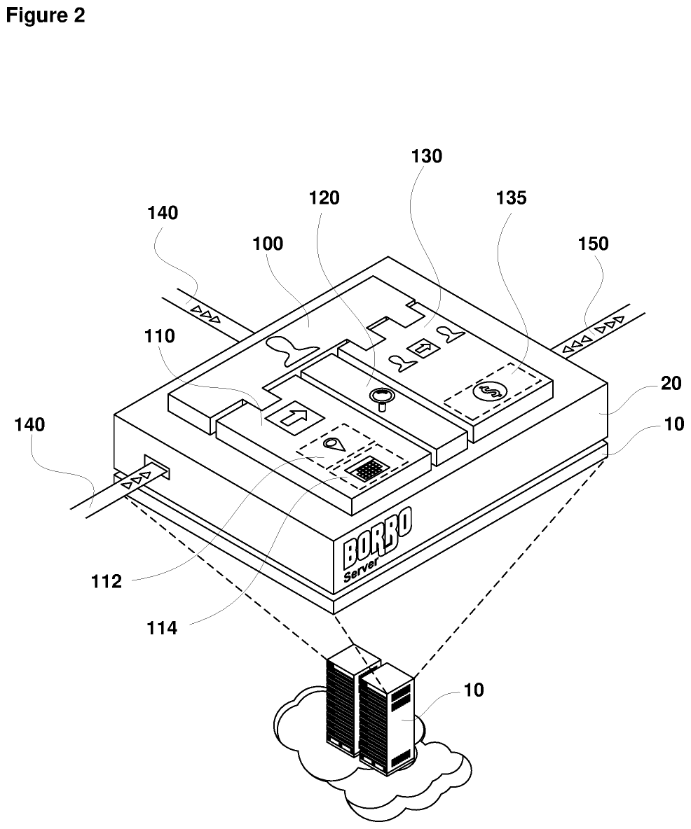

FIG. 1 is divided into Segments which are further expanded in subsequent FIGS. 2 to 6. In particular, Segment 200 of FIG. 1 shows the server component (20) with which the software application (40) operating on data communication devices (50) are configured to communicate. It will be apparent to the person skilled in the relevant field of technology that the software application (40) may be a mobile application or a web application and that, similarly, the data communication device (50) utilised by the users (30) may be a mobile device or computer device. The server component (20) is additionally detailed in FIG. 2.

The skilled person will appreciate that the steps described herein may be executed by the devices (50), wherein such operations are facilitated by the software application (40) operating on each device. According to another implementation of the present invention, the server (20) is programmed to provide all of the functions described herein where they cannot be provided locally on the user devices (50) or where it may be impractical to do so. In other words, the steps described herein as performed by the device (50), or components of the device (50) that are described as implementing the invention, may be associated with hardware that is located externally of the device (50), such as the remote central server (20) for example (i.e. in a distributed architecture). Different arrangements are possible in this regard, and alternate variations will be apparent to the person skilled in the relevant field of technology.

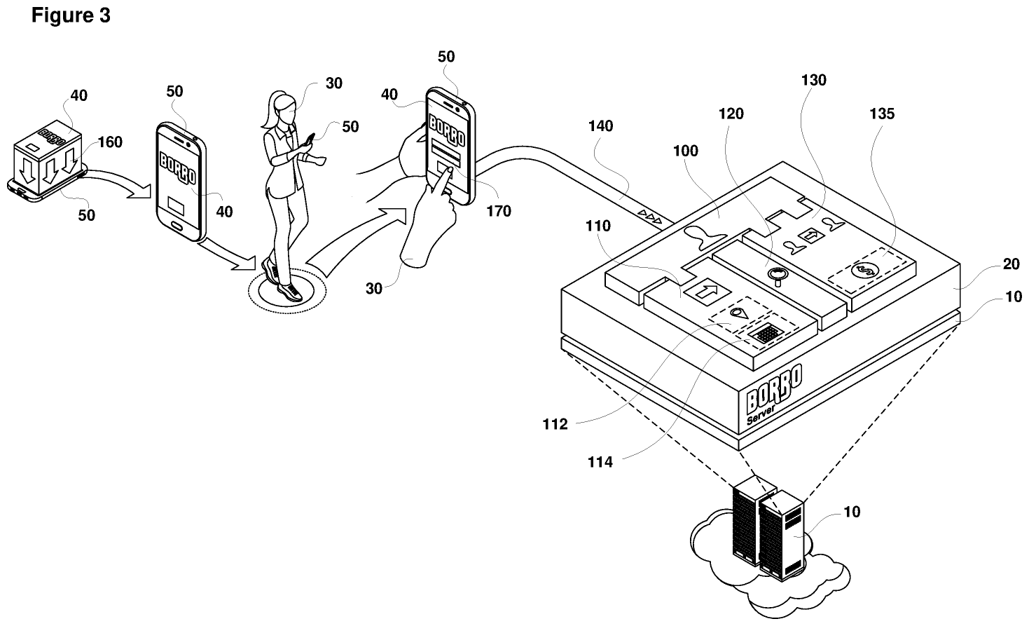

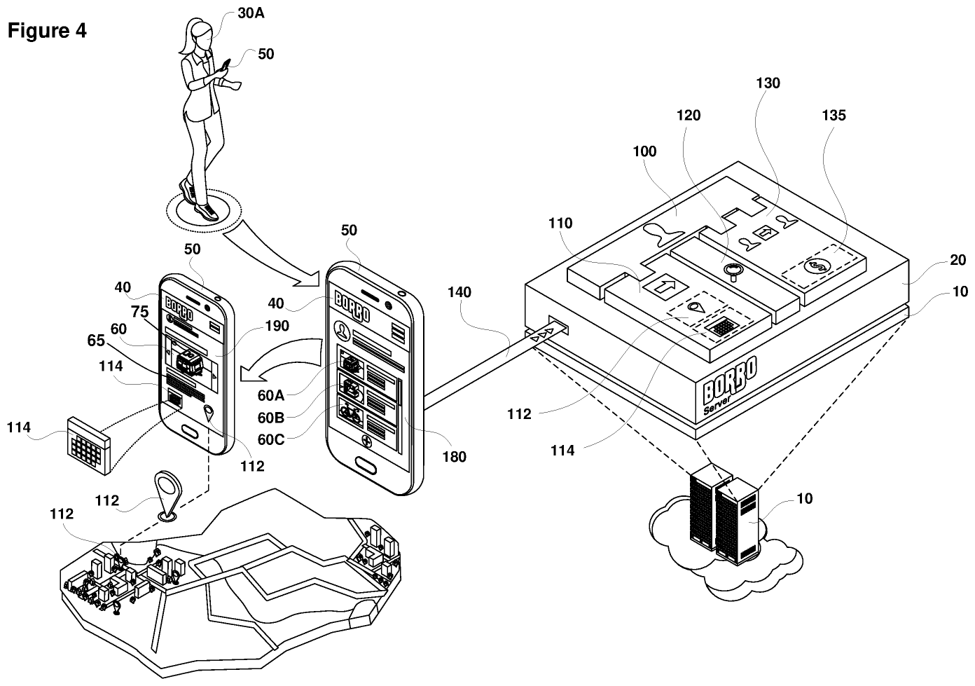

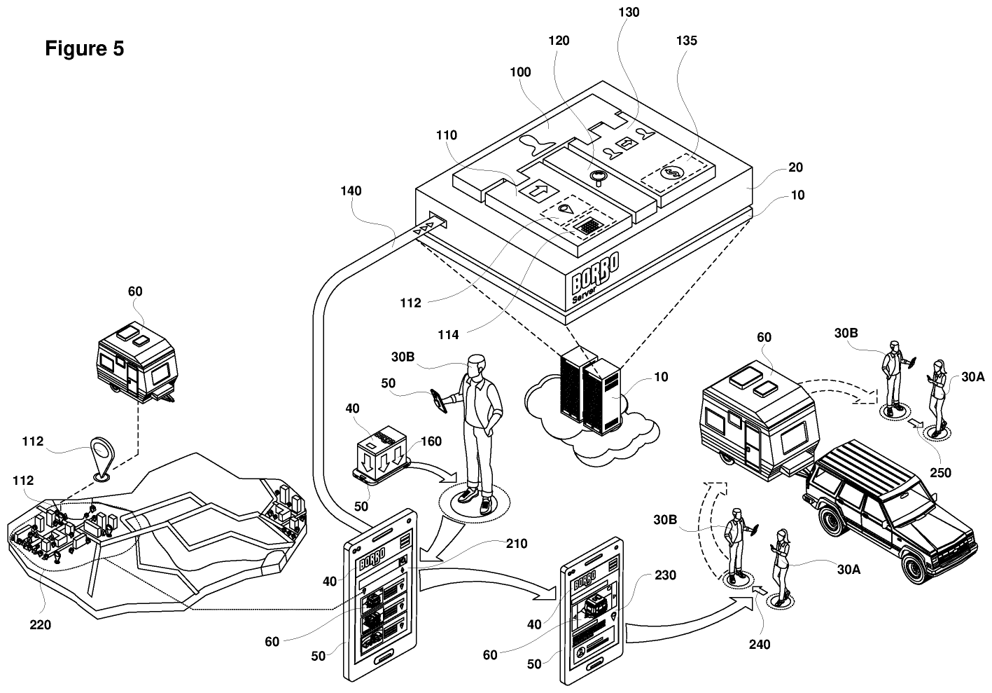

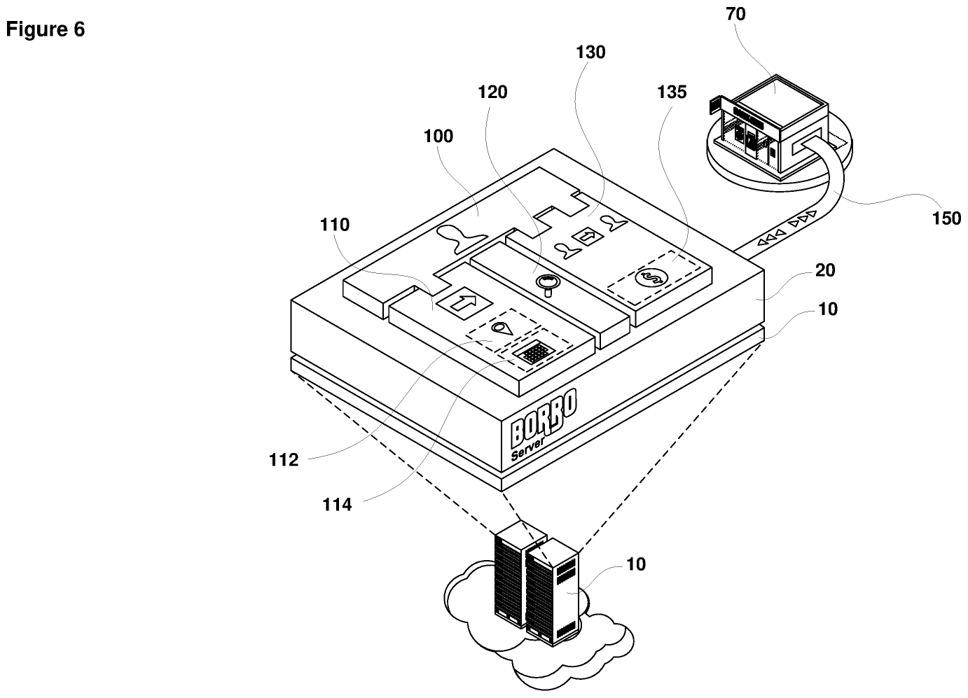

Segment 300 of FIG. 1 shows a user (30A) downloading and installing the application (40) and subsequently accessing the application (40) in order to establish an account, as further detailed in FIG. 3. Segment 400 of FIG. 1 illustrates how user (30A) may establish a user profile as well as various item listings (60A, 60B, 60C, etc) as shown in interface (180), with the ability to add/edit details in respect of each item listing as shown in interface (190), which is further detailed in FIG. 4. Segment 500 of FIG. 1 illustrates how the second user (30B) may conduct a search for items of interest as shown in interface (210), wherein the listed search results may include the item (60) listed by user (30A), and confirm interest in an item including arranging specific details such as pick-up and drop-off times and locations, as detailed in FIG. 5. Finally, Segment 600 of FIG. 1 illustrates the ability of the software application (40) to process payments between users (30A) and (30B) through one or more of their financial institutions (70), as detailed in FIG. 6.

As mentioned above, FIG. 2 shows in greater detail segment 200 of FIG. 1 and, in particular, FIG. 2 shows the server component (20) which includes infrastructure (10) upon which the platform of the present invention operates. The infrastructure (10) may be local or cloud-based.

The central server (20) may operate one or more computer processors and maintain one or more databases to enable the following functionality and/or storage:
User account register (100) storing user details such as name, age, address, contact details, identifiers such as driver's license or passport details, and any additional data which may be relevant for the purpose of identifying each user (30). Where possible, these details will be verified using identification verification services, and each user (30) may be required to provide an image of themselves for further identity verification;
Item register (110) representing a register of items that have been listed by users (30A) as being available to borrow and/or rent (e.g. a caravan (60A), a sewing machine (60B), a bicycle (60C), etc), including the description (65) of each item and any related information such as photos (75) and any conditions or fees required to be satisfied for borrowing or renting the item. The entries in register (110) may also contain the location (112) of the item (60), as well as the availability (114) of the item (60); and
Search engine functionality (120) that allow users (30B) to search the register (110) for an item of interest, the functionality (120) utilising an algorithm that ensures that listings that sufficiently match the particular item or item category identified based upon search criteria entered by user (30B) are included in the search results. The algorithm further ensures that only those items residing within a predetermined geographical region of the user (30B) are listed, and such geographical regions may be defined by the second user (30B) or automatically implemented based upon a predetermined search region surrounding the user (30B). The functionality (120) also allows users (30B) to enter search criteria such as the item, category of item, price they are prepared to pay, availability and/or location of the item;
Legal information database (130) which stores details relating to legal agreements and/or conditions established between users (30A) and (30B) regarding the lending and/or renting of an item (60), including any terms and conditions of the borrow/rent transaction and any payments (135) required to be transferred in settlement of such transactions; and
Payment gateway (135) enabling payment of fees between users (30A) and (30B) for the borrowing and/or renting of items (60).

FIG. 2 also depicts that server (20) is configured to enable communication (140) with the user devices (50) and, in particular, the software applications (40) operating on each user device (50), as well as communication (150) with one or more financial institutions (70). Such communications may occur via the internet or similar network.

FIG. 3 shows in greater detail Segment 300 of FIG. 1 and, in particular, the steps associated with a user (30A) installing the application (40), which may be achieved by downloading the application (40) from an application store. A similar process may apply with respect to user (30B) installing the application (40). Each user (30) may create an account using the application (40) and the account information may be stored in the account register (100), and as described above, the user account register (100) may capture information sufficient to enable each user (30) to be correctly identified.

The process of installing the application (40) is indicated by arrow (160), and interface (170) is also shown which allows each user (30) to download and install the application (40) in order to access the functionality thereof, including to create and maintain a user profile as shown in interface (180). In other words, once the application (40) has been accessed by a user (30), the user (30) may be presented with an interface, identical, or similar to, interface (180) to allow the user (30) to create and maintain a user profile, including providing the user (30) with the ability to add/edit details and access functionality of the application including to list items, amend existing listings, add additional listings, and search for items. Upon uploading sufficient information, each user (30) will be successfully registered such that the user (30) becomes a registered user who may then utilise the functionality of the application (40) in accordance with the subscription level of the user (30).

FIG. 4 shows in greater detail Segment 400 of FIG. 1, and in particular, the use of the application (40) by user (30A) to establish a profile and create an item listing (190) relating to an item (60) which the user (30A) prefers to make available for borrowing or renting. Once the user (30A) has created their account, they can then establish their profile including adding and maintaining one or more items that they prefer to lend or rent to other users, such as user (30B). Once added, the items will become available in search results relating to search requests posted by other users (30B) if a match is determined (according to particular matching criteria) between the item listed and the search request.

For example, when the second user (30B) conducts a search identifying a particular item or a particular category of items of interest, the second user (30B) may be presented with only those listings that match (according to the matching criteria) the particular item or particular category of items specified in the user's request, and only those listings within a predetermined geographical region of the second user (30B). In this regard, the software application (50) may enable the second user (30B) to define the predetermined geographical region surrounding the second user (30B), or the region may be pre-defined and applied automatically by application (50). It is to be understood that more than one geographical region may be selected or defined.

When listing an item, the user (30A) may also specify the dates and times that the item (60) is available to be borrowed or rented, as shown in calendar (114) of FIG. 4. In this way, the user (30A) may specify one or more periods of time for which the item may be borrowed or rented, and the user (30A) may also specify a rental fee. Where the item (60) is only available for borrowing (i.e. not available for renting), the user (30A) may be prompted to include one or more periods of time for which the item may be borrowed, and the listing may be automatically updated to confirm that no fee is payable for borrowing the item (60). The first user (30A) may also be provided with one or more recommendations to assist with the listing of items. For example, where the user (30A) lists an item for renting out, the recommendation provided to user (30A) may relate to a suitable rental fee for the particular item listed as compared with market value or other comparable data (e.g. as compared with rental fees submitted by other registered users in respect of the same or similar items).

FIG. 5 shows in greater detail segment 500 of FIG. 1, and in particular a process involving a user (30B) searching for an item of interest (caravan (60)) that they prefer to borrow or rent. It will be appreciated in FIG. 5 that once the user (30B) has downloaded and installed (160) the application (40) and logged in to access an item search interface (210), the user (30B) may use the interface (210) to enter a request including a search for items of interest. For example, user (30B) may enter a description of the item using keywords (e.g. “caravans”), or use some other search criteria as described earlier, resulting in the identification of an item which may then be displayed on the device (50) of user (30B), or a broader item category whereby one or more items falling within the category may be displayed.

It will be appreciated that the search functionality may enable users (30B) to specify any number of search criteria, and additional examples of search criteria may include keywords relating to the borrow/rent conditions, for example. In this way, the user (30B) may filter the results to particularise their search results.

In the particular embodiment shown in FIG. 5, the user (30B) specifies a geographical search area (220) within which to locate caravans (60), however as described earlier, the application of a geographical boundary may also automatically be applied without the need for user (30B) to specify a search area or region.

Once user (30B) selects a particular item displayed in the list generated in interface (210), the user (30B) may be presented with an additional interface (230) which includes the particular item detail, and which enables the user (30B) to commit to the borrowing/renting transaction (thereby also agreeing to the borrowing/renting terms and conditions). Once user (30B) commits to the transaction, a payment (135) may be required depending upon whether the item is being borrowed or rented, and this process may also enable a communication gateway to be established between the users such that user (30B) may make contact with user (30A) who is lending or renting the item to user (30B). Interface (230) may also include a hyperlink which when selected causes the fine-print relating to the terms and conditions to be displayed.

Once the transaction is confirmed, the availability (114) of the item in search results generated from that point on may be automatically updated to reflect that the item is not currently available for borrowing or renting. However, it is to be understood that even if the status of a particular item is currently “borrowed” or “rented”, the item listing may continue to be presented to other users in search results since the other users may be interested in borrowing or renting the item after the item has been returned. In this regard, the item listing included in the search results may specify that the item is not currently available, and may further specify an expected return date for the item. In addition to specifying the return date, users may be provided the ability to pre-book the item for collection upon its return. In an alternative embodiment, the search results may include only those items that are currently available for borrowing or renting.

Interface (230) may also present a plurality of rental period options, thereby prompting the user (30B) to select one of the rental period options. For example, the item may be available for rent for one day, three days, seven days, etc, and the user (30B) may be prompted to make a selection of one of the presented options. Different fees may apply to different rental periods, and in this regard, user (30A) may elect to provide incentives for renting the item for longer by offering discounted fees in respect of the longer rental periods. The recommendations that are generated and provided to user (30A) may also include recommendations relating to the types of incentives which they may choose to apply to different rental conditions, such as different rental periods.

The second user (30B) searching for items of interest may also be provided with one or more recommendations, including a recommendation regarding whether a listed rental fee is not commensurate with fees previously paid for such items by the user, or fees proposed by other users (30A) in respect of the same or similar items, for example.

The searching algorithm (120) may determine a match between the item requested to be listed by the user (30A) with the particular item or item category identified in the search request submitted by user (30B) when similarities between the first and second user requests satisfy a matching criteria or similarity threshold. Similarities between the listing request and the search request may be based upon similarities between particular letters, words, numbers and/or symbols included in each request. Such letters, words, numbers and/or symbols may be identified utilising one or more optical character recognition (OCR) techniques, and the similarity threshold may be based upon the extent to which particular letters, words, numbers and/or symbols in the respective requests match or closely match. In some implementations, machine learning techniques may also be utilised to improve the optical character recognition over time.

Various combinations of letters, words, numbers and/or symbols may be allocated particular similarity scores which may be saved in a cloud-based facility for use by the platform and, in use, the platform may reference the stored similarity scores when determining the similarity between listing and search requests. For example, when a new search request is received from user (30B) that includes one or more keywords, and those keywords are compared against words that exist in active product listings requested for posting by users (30A), the cloud-based facility may be utilised to determine whether the combination of particular words under comparison are recognised and already have a similarity score assigned. If the same combination of keywords exists in the cloud-based facility and a particular similarity score has already been assigned, then the same similarity score may be automatically assigned to the combination of words now being compared. Where there is more than one element in each request being compared, then multiple scores may be identified and a combined score may be determined and appropriately allocated.

Provided the similarity score (or combined score) exceeds a predetermined minimum, then the particular product listing and the search request may be considered to satisfy the similarity threshold and the particular listing may automatically appear in the search results presented to user (30B). The skilled addressee will appreciate that this step may then repeat, or occur simultaneously, across all remaining product listings in order to retrieve and display, substantially in real-time, a more relevant subset of product listings for display to the searcher (30B).

Where stored scores are not able to be located for a particular pair of letters, words, numbers and/or symbols or combination thereof under comparison, a determination of whether the first and second requests satisfy the similarity threshold may be based upon an analysis of remaining letters, words, numbers and/or symbols present in the respective requests that may also be compared. Where such additional elements do not exist, the user (30B) may be requested to enter additional search terms such as additional keywords or the like. In this scenario, where user (30B) provides additional letters, words, numbers and/or symbols sufficient to enable automatic allocation of a similarity score and hence determination of whether a similarity threshold has been satisfied, a new similarity score may be generated and assigned with respect to the original letter, words, number and/or symbol entered by user (30B) for which there was previously no score available. Any newly generated scores may then be stored in the cloud-based facility along with details of the particular letters, words, numbers and/or symbols that were being compared, for future reference. In this way, the similarity scores may be updated according to successful matchings between listing and search requests and hence, the cloud-based facility may learn from successful matchings between requests such that higher similarity scores may be allocated according to the particular combination of letters, words, numbers and/or symbols used in successfully matched product listings and search requests.

FIG. 5 also shows the user (30B) meeting with user (30A) for the purpose of picking up (240) of caravan (60) from user (30A) who has agreed to lend or rent the caravan to user (30B), as well as the return (250) of the caravan back to user (30A) in accordance with the agreed lending/rental period. When the user (30A) receives the item back, the user (30A) may manually update the item availability (114) to reflect that the item is once again available for borrowing or renting. Alternatively, this could be achieved automatically based upon, for example, each user confirming in application (40) that the transaction has been completed in accordance with the agreed terms and conditions.

Where a payment is required to rent an item, the user (30A) may be prompted to provide their bank account details, e.g. in interface (230), or alternatively, such details may be entered when user (30A) first registers to use the software application and hence such details may automatically populate in interface (230). The software application may subsequently provide a payment gateway to user (30B) to enable the user (30B) to make a payment to user (30A) and, in particular, to the financial institution (70) associated with user (30A). The communication (150) between the server (20) and the financial institution (70) associated with user (30A) is shown in FIG. 6 which details segment 600 of FIG. 1. It is envisaged that the platform could also support payments via Credit Card, EFT, PayPal and similar payment platforms.

Accordingly, the platform may facilitate the processing of payments between users (30) when items are rented. The platform administrator may also receive a payment when an item is rented, and according to one implementation, a subscription fee may be automatically deducted from the rental payment fee.

The software application (40) may also enable the users (30) to provide ratings with respect to their interaction with other users (30), and such ratings may also be viewable in the user profiles. For example, the user (30B) may rate the user (30A) regarding the item (60) that they borrowed or rented and the extent to which the item matched the description provided in the item listing. Likewise, the user (30A) may rate the user (30B) based upon factors such as when the item was returned (i.e. on time or late) and/or the state of the item upon its return.

Data relating to the activity of users (30) may be recorded for the purpose of generating statistical data including in relation to those items that users seek to borrow and/or rent most regularly, items that are sought but which are typically not able to be fulfilled by users (30A) within a particular geographical region or regions, etc. Potential opportunities may arise from collating such data, including the identification of sales or rental opportunities for third party retailers to fulfill the requirements of the users (30B) seeking to borrow and/or rent items of interest. For example, a retailer may view the data and choose to start offering particular items for rent (in addition to purchase). In another example, a retailer may choose to target those users with advertising in relation to the items of interest, including when the particular item is on sale.

Search histories may also be retained to enable users, such as user (30B), to revive a previous search. In addition, any search conducted by user (30B) may remain active until such time that an item of interest is located. For example, if a match is not immediately identified, the search may remain active and may automatically update based upon new items that are listed by users (30A), or newly available items, so that user (30B) seeking to borrow or rent an item of interest may be notified of the newly listed item or the item which has just been made available (e.g. by a push notification, text message or email).

As used herein, the term “central server”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. A computer-implemented method including:
receiving, by one or more processors, a request from a data communications device associated with a first user of a plurality of users to list an item as available for borrowing and/or renting, the first user request including:
information relating to the item including a description of the item and a location of the item;
generating, by one or more processors, a listing in which the item description is displayed;
receiving, by one or more processors, a request from a data communications device associated with a second user of the plurality of users to search for a particular item or a particular category of items in respect of which the second user has an interest, the second user request including:
information relating to the second user including a location of the second user;
based on the item requested to be listed by the first user being determined as a match for the particular item or the particular category of items included in the second user request, and further based on the location of the item residing within a predetermined geographical region of the second user, including the generated listing in search results presented to the second user.

2. A method according to claim 1, further including:
providing a search facility enabling the second user to conduct a search for a particular item or a particular category of items of interest,
wherein in response to a search conducted by the second user using the search facility, the second user is presented with only those listings that match the particular item or particular category of items specified in the first user request, and only those listings within the predetermined geographical region of the second user.

3. A method according to either claim 1 or claim 2, wherein each of the first and second users utilise a software application operable on the respective data communications devices to transmit the first and second requests respectively.

4. A method according to any one of the preceding claims, wherein the software application enables the second user to define the predetermined geographical region of the second user.

5. A method according to claim 4, wherein the software application enables the second user to define more than one geographical region.

6. A method according to any one of the preceding claims, wherein determining a match between the item requested to be listed by the first user with the particular item or the particular category of item included in the second user request includes determining that similarities between the first and second user requests satisfy a similarity threshold.

7. A method according to claim 6, further including:
identifying, utilising one or more optical character recognition techniques, letters, words, numbers and/or symbols included in each of the first and second user requests,
wherein the similarity threshold is based upon an extent to which particular letters, words, numbers and/or symbols identified in the first user request match those identified in the second user request.

8. A method according to claim 7, further including utilising one or more machine learning techniques to improve the optical character recognition over time based upon feedback including user feedback regarding an accuracy of optical recognition of particular letters, words, numbers and/or symbols.

9. A method according to either claim 7 or claim 8, further including:
storing, in a pre-defined location, similarity scores for various combinations of letters, words, numbers and/or symbols,
determining, based upon the stored similarity scores, similarity score(s) for particular combinations of letters, words, numbers and/or symbols compared for determining whether the respective user requests satisfy the similarity threshold, and
determining that the similarity threshold is satisfied in respect of the first and second user requests when the determined similarity score(s) exceed(s) a predetermined minimum.

10. A method according to claim 9, further including:
determining similarity scores for any remaining combinations of letters, words, numbers and/or symbols in the respective user requests; and
where more than one similarity score is determined, determining a combined similarity score and whether the combined similarity score exceeds the predetermined minimum.

11. A method according to either claim 9 or claim 10, wherein, in the event a similarity score for a particular pair of letters, words, numbers and/or symbols is not located in the pre-defined location, the method further includes one or more of:
determining the similarity score(s) based upon any remaining letters, words, numbers and/or symbols in the respective user requests; and
prompting the second user to add additional search terms to the second user request to enable the determination of similarity score(s) pertaining to letters, words, numbers and/or symbols added by the second user.

12. A method according to claim 11, wherein any newly determined similarity score(s) for particular combinations of letters, words, numbers and/or symbols are stored in the pre-defined location for future reference.

13. A method according to any one of the preceding claims, further including maintaining a status of the item, including whether the item is currently borrowed or rented, or alternatively, whether the item is currently available for borrowing or renting.

14. A method according to claim 13, wherein, in the event the status of the item is currently borrowed or rented, the item listing is included in the search results presented to the second user based on the respective user requests satisfying the similarity threshold thereby enabling the second user to borrow or rent the item after the item is returned.

15. A method according to claim 14, further including:
updating the item listing included in the search results such that the listing specifies an expected return date of the item.

16. A method according to claim 13, wherein the search results include only those listings relating to items that are currently available for borrowing or renting.

17. A method according to any one of the preceding claims wherein, in the event the first user lists an item for renting, the method further includes:
prompting the first user to include one or more periods of time for which the item may be rented, and a rental fee.

18. A method according to any one of the preceding claims wherein, in the event the first user lists an item for lending, the method further includes:
prompting the first user to include one or more periods of time for which the item may be borrowed, and wherein the item listing is automatically updated to confirm that no fee is payable to the first user for borrowing the item.

19. A method according to any one of the preceding claims, further including:
based upon the second user selecting an item listing from the search results, wherein the item is available for rent, prompting the second user to confirm their intention to rent the item and to confirm the rental period in the event of multiple rental period options.

20. A method according to any one of the preceding claims, further including:
based upon receiving confirmation from the second user regarding an intention to rent the item, prompting the second user to pay the rental fee, or a portion thereof, to the first user.

21. A method according to claim 20, wherein prompting the second user to pay the rental fee includes providing a payment gateway to the second user to enable the second user to make payments into a bank account associated with the first user.

22. A method according to any one of the preceding claims, further including:
prompting users to provide ratings in respect of other users including ratings of first users regarding the items they borrowed or rented and an extent to which the item matched a description provided in the item listing, and ratings of second users based upon timeliness of the return of items and/or as operating or visual appearance of items upon their return.

23. A method according to any one of the preceding claims, further including:
recording data relating to the activity of users for the purpose of generating statistical data in relation to one or more of:
items that users seek to borrow and/or rent most regularly, and
items sought but for which requests are not able to be fulfilled by first users within a particular geographical region or regions.

24. A method according to any one of the preceding claims, further including:
maintaining any search conducted by a second user active until such time that an item of interest is located, such that if a match is not immediately identified, the search will remain active and undergo automatic updates according to new items listed by first users; and
notifying the second user seeking to borrow or rent an item of interest of matching newly listed item(s).

25. A method according to any one of the preceding claims, further including:
generating one or more recommendations for first users listing items for rent, including recommendations regarding a suitable rental fee for the particular item being listed as compared with market value; and/or
generating one or more recommendations for second users searching for items of interest, including recommendations regarding whether a listed rental fee is substantially commensurate with fees previously proposed by other first users in respect of the same or similar items.

26. A system including one or more processors operable to:
receive a request from a data communications device associated with a first user of a plurality of users to list an item as available for borrowing and/or renting, the first user request including:
information relating to the item including a description of the item and a location of the item;
generating a listing in which the item description is displayed;
receiving a request from a data communications device associated with a second user of the plurality of users to search for a particular item or a particular category of items in respect of which the second user has an interest, the second user request including:
information relating to the second user including a location of the second user; and
based on the item requested to be listed by the first user determined as a match for the particular item or the particular category of items included in the second user request, and further based on the location of the item residing within a predetermined geographical region of the second user, including the generated listing in search results presented to the second user.

27. A computer-readable medium having a plurality of computer instructions executable by one or more processors that, when executed, causes the one or more processors to:
receive a request from a data communications device associated with a first user of a plurality of users to list an item as available for borrowing and/or renting, the first user request including:
information relating to the item including a description of the item and a location of the item;
generate a listing in which the item description is displayed;
receive a request from a data communications device associated with a second user of the plurality of users to search for a particular item or a particular category of items in respect of which the second user has an interest, the second user request including:
information relating to the second user including a location of the second user; and
based on the item requested for listing by the first user determined as a match for the particular item or the particular category of items included in the second user request, and further based on the location of the item residing within a predetermined geographical region of the second user, include the generated listing in search results presented to the second user.
